(19) United States
(12) Patent Application Publication
(10) Pub. No.: US 2020/0160196 A1
(43) Pub. Date: May 21, 2020

(54) METHODS AND SYSTEMS FOR DETECTING CHECK WORTHY CLAIMS FOR FACT CHECKING

(71) Applicant: Conduent Business Services, LLC, Florham Park, NJ (US)

(72) Inventors: Sriranjani Ramakrishnan, Chennai (IN); Sandya Srivilliputtur Mannarswamy, Bangalore (IN)

(21) Appl. No.: 16/192,159

(22) Filed: Nov. 15, 2018

(51) Int. Cl. G06N 5/04; G06K 9/62; G06N 3/04; G06F 17/27; G06N 99/00

(52) U.S. Cl. CPC G06N 5/04; G06K 9/6269; G06N 99/005; G06F 17/2785; G06F 17/277; G06N 3/04

(57) ABSTRACT

Methods and systems for automatically selecting a claim for fact checking. In a first stage, a claim can be classified as objective or subjective by an objectivity classifier. If the claim is classified as objective, then in a second stage, the claim is classified as being of public interest or not. If the claim is classified as both objective and of public interest, then the claim can be selected as worthy for fact checking. This approach reduces the workload of automated systems such as data-processing systems, which saves time in performing fact checking operations and results in greater system and network efficiencies.

### TECHNICAL FIELD

Embodiments are generally related to the field of data analysis. Embodiments further relate to the field of fact checking including automatically verifying the factual accuracy of information. Embodiments further relate to methods and systems for determining if claims are worthy of fact checking.

### BACKGROUND

Information is dispersed through the Internet, television, social media and many other outlets. The accuracy of the information is often questionable or even incorrect. Although the Internet was heralded as the beginning of a truly democratic information age where information is freely available and accessible to all (i.e., just a “mouse click” away), it brought with it the curse of misinformation, where lies and half-truths compete head to head with correct facts across the Web.

Given the velocity and volume of information available on the Internet, manual methods of fact checking such information is error-prone, expensive and non-scalable. This has led to the development of automated fact checking techniques. Automated fact checking may first require identification of claims, which need to be fact-checked. A potential claim, in addition to being an objective statement, also needs to contain information, which would be of interest to general public, thereby justifying the expense of fact-checking. Existing approaches for claim identification, model claim identification as a single-step classification problem without factoring in the notion of interestingness to public. They also have focused on mostly identifying claims in political debates only.

While it has been the time-honored duty of journalists to ensure that the public is presented with actual facts and not misinformation, explosion of information available via the Internet has made it virtually impossible for any manual fact checking efforts to be effective, scalable and timely. Hence, there has been considerable research in recent years focusing on automated fact checking of publicly available information.

An automated fact checking pipeline has two major passes namely (a) identifying statements/sentences that need to be fact-checked which can be termed as the claim identification phase and (b) verifying the identified claims using external knowledge sources for veracity, which can be referred to as the claim verification phase. Given that the textual content on the Internet may be on the order of exabytes, fact-checking each and every statement/sentence is a Herculean task even with state of the art computing resources. An earlier study has found, for example, that it takes only 2.5 hours for a meme to move from being reported in the news media to becoming a part of blogs across the Internet.

Given such a rapid traversal of information across the Internet and the fact that false news spreads much faster than true information, fact checking needs to be timely for it to be useful. Given that fact checking can require considerable computing resources, distinguishing between text containing a claim versus text that simply expresses an opinion is critical for the success of any automated fact-checking system. Claim identification namely classifying which sentences in a text are potential claims for verification is an important task in the fight against misinformation and fake news.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the specification, claims, drawings, and abstract as a whole.

It is, therefore, one aspect of the disclosed embodiments to provide methods and systems for automatically verifying the factual accuracy of information.

It is another aspect of the disclosed embodiments to provide for a two-step method and system for determining if claims are worthy of fact checking based on a determination of objectivity and public interest.

It is a further aspect of the disclosed embodiments to provide for the use of a neural network including an objectivity classifier for use in classifying the objectivity of a claim.

The aforementioned aspects and other objectives can now be achieved as described herein. Methods and systems for automatically selecting a claim for fact checking. In a first stage, a claim can be classified as objective or subjective by an objectivity classifier. If the claim is classified as objective, then in a second stage, the claim is classified as being of public interest or not. If the claim is classified as both objective and of public interest, then the claim can be selected as worthy for fact checking. This approach can reduce the workload of automated systems (e.g., data-processing systems), which saves time in performing fact checking operations and results in greater system and network efficiencies.

The disclosed embodiments include a two-step process for claim identification which models in the criteria of objectivity, and interestingness to public. A dataset can be curated, which contains text from multiple domains for claim identification. The disclosed two-step approach improves over the conventional single step model for claim identification and is applicable across multiple domains for claim identification.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a block diagram of a system for claim identification, in accordance with an embodiment;

FIG. 2 illustrates a block diagram of a system that includes an implicit objectivity classifier, in accordance with an embodiment;

FIG. 3 illustrates a high-level flow chart depicting logical operational steps of a method for determining if a claim is check-worth for fact checking, in accordance with an embodiment;

FIG. 4 illustrates a high-level flow chart depicting logical operational steps of a method for determining if a claim is check-worth for fact checking, in accordance with an alternative embodiment;

FIG. 5 illustrates a schematic view of a computer system, in accordance with an embodiment; and

FIG. 6 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or a combination thereof. The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Several aspects of data-processing systems will now be presented with reference to various systems and methods. These systems and methods will be described in the following detailed description and illustrated in the accompanying drawings by various elements, blocks, modules, components, circuits, steps, operations, instructions, processes, algorithms, engines, applications, etc (an “element” or “elements). These elements may be implemented using electronic hardware, computer software, or any combination thereof. Whether such elements are implemented as hardware or software depends upon the particular application and design constraints imposed on the overall system.

An element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. The term software can be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

Definitions of one or more terms that will be used in this disclosure are described below without limitations. For a person skilled in the art, it is understood that the definitions are provided just for the sake of clarity, and are intended to include more examples than just provided below.

As discussed, the identification and selection of claims for fact checking is a problem inherent with convention fact checking methods and systems. Given a set of sentences, claim identification boils down to classifying each sentence as a potential claim or not. This brings up the question of “what constitutes a claim?”. Factual objective statements/utterances are potential claims which need to be verified, whereas subjective opinions should not be checked. For example, “Trump owns properties in India worth 500 million” is an objective statement, whereas “Trump is the worst President America ever had” is a subjective statement.

While a statement needs to be objective/factual to be an eligible candidate for claim, not all factual sounding/objective statements need to be fact-checked. Only if the statement contains some information, which would be of interest to the public, may it be required to undergo the rigor and labor of fact checking it. An objective statement such as “Trump donated two million to charity in 2016” can be identified as a claim for fact-checking, and an objective statement such as “Last Tuesday, we had lunch at Tiffany's” may not be identified as a claim for fact checking because it does not contain any information which would be of interest to general public.

Note that as utilized herein, the term objective can refer to something that is unbiased and impartial and which is not influenced by personal feelings or opinions in considering and representing facts. The term subjective can refer to something that is based on or influenced by personal feelings, tastes, or opinions. In addition, the term claim can refer to statements or assertions that need to be fact checked. Such a claim may state or assert that something is the case, typically without providing evidence or proof. Hence, it may be necessary to fact check such a claim made in, for example, a textual representation such as a statement, sentence or paragraph, or in other contexts, such as an audio or video recording. The terms fact check or fact checking can refer to the process, method, system or computer program product or computer readable medium of confirming the truth of (e.g., an assertion made in speech or writing). Fact checking or fact check can thus involve the process of attempting to verify or disprove assertions made in speech, print media or online content. The practice is essential for integrity in any area where claims are made, including government, journalism and business.

While we note that defining what constitutes a potentially valid claim is subjective, we argue that typically claims have two important characteristics. First, the potentially valid claim should be objective and not a subjective opinion, which can be referred to as the objectivity criterion. Second, the potentially valid claim should be of interest to the public, which can be referred to as the public informational interest criterion.

We hypothesize that these two criteria are important in claim identification and that these two criteria are well-distinct and hence need different sets of textual features to identify them. The novel claim identification approach disclosed herein thus can be implemented as part of a two-step process, wherein the first step differentiates between subjective and objective statements and the second step differentiates between objective statements, which are of public informational interest and those that are not. While earlier work has called out the distinction between check-worthy factual statements and unimportant factual statements, it did not concretely define what constitutes check-worthy factual statements nor identify public informational interest as a factor for separating out mere objective statements from those claims which need to be fact-checked.

Prior work has typically considered claim identification as a single step classification problem, modeling it either as a single-step 3-class classification problem (non-factual, unimportant factual sentences and check-worthy factual sentences) or as a single-step binary classification problem (check-worthy or not), or as a ranked list of check-worthy claims based on their single-step binary classification score. These approaches do not distinguish between features, which characterize a sentence as objective and features which characterize it as of informational interest to public. Disentangling these characteristics is important in claim identification as will be discussed in greater detail herein.

It is believed that the disclosed embodiments constitute the first work in claim identification for fact checking, which specifically identifies objectivity and public information interest as two distinct criteria for check-worthy claim identification. As will be discussed in greater detail herein, a novel set of features is provided for each of these two steps including the implementation of classifiers using such features for these two steps.

Note that the term “classifier” can refer to a device, machine, module or algorithm or a combination thereof that that implements classification in a concrete implementation, known as a classifier. In some cases, the term “classifier” can also refer to the mathematical function, implemented by a classification algorithm, that maps input data to a category. Each classifier discussed herein may can be implemented by a neural network or may comprises a neural network or a portion of a neural network. In some cases, a classifier may be implemented by a machine learning algorithm. Examples of classifiers, which can be adapted for use in accordance with the disclose embodiments include, for are not limited to linear classifiers (e.g., logistic regression, Naive Bayes), support vector machines, decision trees, boosted trees, random forest, neural networks, and nearest neighbor.

Earlier work in claim identification has focused solely on claim identification in the political arena with almost all the datasets used being that of political debates. Given the wide-spread of misinformation on the web pertaining to various domains such as healthcare, consumer, religion, and social sciences, it is important to consider textual content not just from one domain such as politics, but from different domains. Not that a specific operation can be providing to express the claim (or claims) as textual representation such as a claim statement, paragraph, or one or more sentences.

Given the lack of datasets with multiple domain coverage, a new dataset can be curated, which is composed of claims from multiple domains that are publicly available. That is, a step or operation can be implemented to curate a data set composed of one or more claims from among a group of claims from multiple domains, which may vary in scope, nature, and subject matter. The novel two-step claim identification approach disclosed herein has been evaluated with such a dataset and results demonstrate that it improves performance over a baseline by 4%.

The disclosed embodiments thus formulate claim identification as a two-step problem, with the first step including identifying objective statements and the second step involving identifying those objective statements, which would of public informational interest. A new dataset is then curated, which includes claims from multiple domains including politics, history, medical, and entertainment.

As discussed earlier, fact checking involves the task of ensuring that information presented to the public is factually accurate. This requires identifying the claims that need to be fact-checked and then actually performing the process of fact-checking the identified claims. Claim identification has typically been performed as a single step classification process of labeling each sentence in a given text as a claim that needs to be fact-checked or a non-claim. Prior work has used a set of features for classifying claims vs. non-claims by considering textual characteristics such as bag of words, Part of Speech (POS) tags, sentiment contained in the text, presence of named entities, speaker and stance of the sentence. These earlier works, however, do not clearly call out the characteristics that can assist in identifying a claim that needs to be fact-checked from all other non-claims.

Factual objective statements/utterances are potential claims that need to be verified, whereas subjective opinions should not be checked. While a statement needs to be objective/factual to be an eligible candidate for a claim, all factual/objective statements do not need to be fact-checked, because the purpose of fact checking is to determine whether a claim is true or not and this verification needs to be performed only if the statement contains information of interest to public.

For example, consider the following 2 statements: (1) I had lunch yesterday with my college mate at Hotel Plaza (2) Donald Trump had a luncheon meeting with German Chancellor on the eve of NATO summit. Both are factual statements. While both can be potential candidate claims, statement (1) is about a commonplace event and does not involve any public entities/events/attributes which would be of interest to public. Hence, it may not be necessary to verify the authenticity of statement (1). On the other hand, statement (2) involves public entities and verifying the authenticity of this statement/claim may be necessary to ensure that this information (which may be of interest to the general public) is needed.

Thus, it is important to note that claim detection involves two distinct processes and each of these processes have distinct linguistic characteristics/features. The first characteristic is that it should be objective/factual. We denote this by objectivity criterion. The second characteristic is that the information contained should be of such interest/useful to the public that its veracity needs to be verified. We denote this by public informational interest criterion.

Prior work in this area has not make this distinction in claim detection. Such conventional approaches typically use a jumbled/mixed set of features that are associated with both of these characteristics for claim detection. For instance, earlier work uses a combination of event in the past indicated by the presence of POS tag VBZ and presence of named entities as two major features for claim detection. Consider this example: S3: I loved watching the movie series Mission Impossible over the years and Tom Cruise is just awesome. Since this statement may score “high” on both features, it may be detected as a claim that may be incorrect and which may need to be fact checked.

This statement is of no-interest to the general public as (a) it describes an individual's preference about movies which is not of interest to public (hence fails the public interest criterion). Though this sentence talks about an event occurrence namely/loved watching movie series Mission Impossible, it is not a claim that is of public interest, and hence does not need to be verified. Thus, separating out these two defining characteristics of claims that need to be fact-checked, is of importance in accurately narrowing down the set of claims, which do need to be fact-checked.

Much of the earlier work in claim identification for fact checking suffers from two issues. First, these earlier approaches do not model the characteristics of objectivity and public informational interest distinctly, which can result in incorrect classification. Consider these two statements: S6: The profits of Intel has been climbing by ten percent over last ten years and S7: My leg pain has been increasing over the past one hour and is now double what it was in the morning. While S6 is a potential claim for fact-checking, S7 is not, since it is not of public informational interest. When these sentences, however, are passed to a state of the art (SoTA) claim detection system both statements attain a very close score (0.57 vs. 0.53).

Second, claim identification systems have focused mostly on political debates datasets, which makes their performance regarding non-political claims poor. Consider the following examples: S8: MMR Vaccine contains vaccines for measles, meningitis and rubella virus and S9: MMR vaccine can cause autism in young children. It is obvious that both of these are valid claims for fact checking, however existing SoTA systems do not score them highly as check worthy claims, assigning them scores of 0.37 and 0.21 well below the claim threshold.

Given these two issues with existing claim identification methods, the disclosed embodiments for claim identification can address these issues. Based on the above illustrative examples, we hypothesize that modeling claim identification as a two-step process wherein step (1) involves checking for objective/factual statements and second stage classifier involves checking for the criterion of public informational interest, would be effective compared to single step classification schemes. Hence, the disclosed embodiments include a two-step classifier for claim identification as described in greater detail herein.

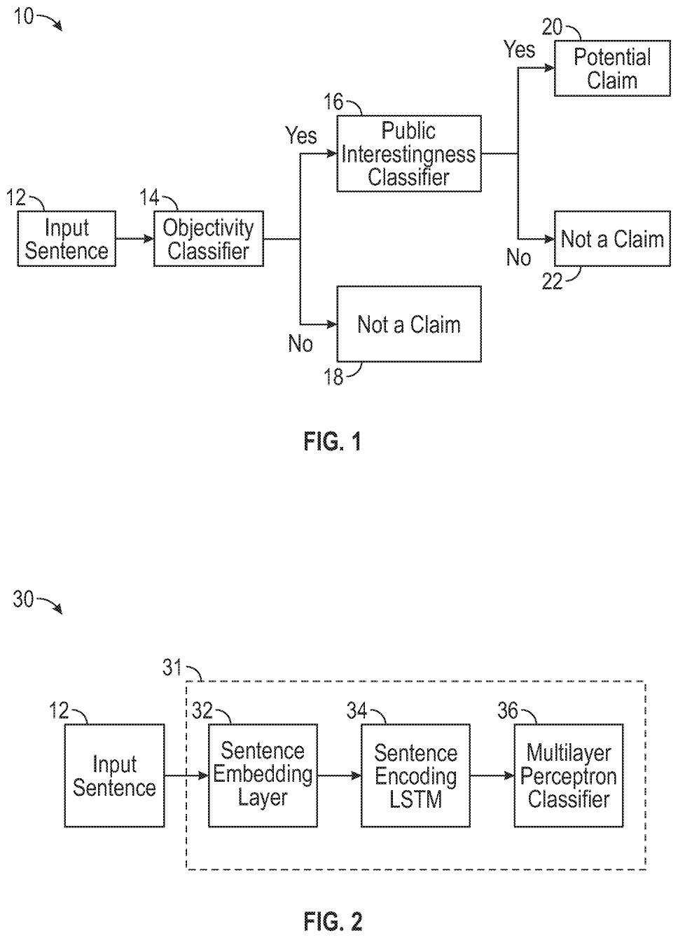

FIG. 1 illustrates a block diagram of a block diagram of a system 100 for claim identification, in accordance with an example embodiment. The system 100 may be implemented in the context of a data-processing system such as, for example, the data-processing system 400 and system 459 shown in FIGS. 7-8 herein. The system 100 models the problem of claim identification as a two-step process. The first step or operation of such a process involves the use of an objectivity classifier 14, which classifies a given input sentence 12 as subjective or objective. This is a binary classifier, which uses a number of linguistic content driven features of the input text to decide whether it is subjective or objective.

Only those sentences, which are classified as objective/factual statements, are passed to a second step classifier, which is the Public Informational Interest classifier 16 shown in FIG. 1. The classifier 16 facilitates identifying sentences containing information that would be of interest to general public. Such a classifier can be referred to a public interestedness classifier. Objective sentences which are found to be containing information which would be of interest to public are classified as potential claim candidates 20, in this two step approach. We next describe each of the two steps of this embodiment.

The objectivity classifier 14 is meant to filter objective sentences from subjective sentences. For a sentence to be a claim that needs to be verified, it needs to be factual or objective. Subjectivity can be defined as the quality of being based on or influenced by personal feelings, tastes, or opinions and the quality of existing in someone's mind rather than the external world. Given this definition that subjectivity is a matter of an individual perception, subjective statements (statements expressing feelings opinions/emotions/thoughts) are not valid claims since they do not contain objective facts and hence cannot be candidates for verification by an external third party source, independent of the opinion holder.

Hence, the first stage of filtering sentences to mine-check worthy claims can involve detecting whether such claims contain objective facts or whether they are subjective statements. Thus, in a first stage, a step or operation can be implemented for classifying a claim as objective or subject. In a second stage, a step or operation can be implemented for classifying the claim as being of public interest or not, if the claim was classified as objective in the first stage.

Two models of a binary objectivity classifier can thus be implemented using (i) explicit features termed as explicit feature driven objectivity classifier and using (ii) the neural sentence representation learned by the model without explicit feature extraction termed as an implicit objectivity classifier. Therefore, the objectivity classifier 14 can be implemented as an explicit feature driven objectivity classifier or an implicit objectivity classifier.

In an example embodiment, a set of content-based features can be utilized for classifying a sentence as objective or subjective. The text can be represented, for example, using a standard bag of words model representation. In addition, we capture Part of Speech Tags information for the text, and the sentiment contained in the text as features for subjectivity. Certain dependency relations in the text are also good indicators for subjectivity. For instance, dependency relations such as adjective modifier relation (such as “generous act”) or an adverbial modifier relation (such as “absolutely brilliant”) can serve often to indicate opinions. The presence of these dependency relations can be used as an additional feature for the objectivity classifier 14.

We can augment our representation using external lexicons for identifying terms, which can be potential indicators of subjectivity. The lexicons can include MPQA subjectivity lexicon, NRC Emotion Lexicon and sentiment lexicons. The count of terms present in external subjectivity and emotion lexicons can also be used as an additional feature in our feature vector. The constructed feature vector for the input can be then fed to a standard supervised learning based classifier. As will be discussed in more detail, experiments have been performed using different classifiers as disclosed in the experimental section herein. Note that MPQA refers to “Multi-Perspective Question and Answer” and can relate to MPQA resources such as, for example, an MPQA Opinion Corpus that can contain news articles from a wide variety of news sources manually annotated for opinions and other private states (i.e., beliefs, emotions, sentiments, speculations, etc.).

FIG. 2 illustrates a block diagram of a system 30 that can include an implicit objectivity classifier 31, in accordance with an example embodiment. Note in FIGS. 1-2, identical or similar parts or elements are generally indicated by identical reference numerals. In addition, each of the various blocks or elements shown in FIGS. 1-2 may be implemented as a module as discussed in greater detail herein. For example, the objectivity classifier 14, may be implemented as an objectivity classifier module and the public interestingness classifier 16 may be implemented as a public interestingness classifier module.

In some embodiments, the implicit objectivity classifier 31 shown in FIG. 2 can be utilized to implement the objectivity classifier 14 shown in FIG. 1. The implicit objectivity classifier 31 can be configured as a module that can include a sentence-embedding layer 32, which outputs a signal that can be then fed as input to a sentence-embedding LSTM (Long Short-Term Memory) 34. The LSTM 34 in turn can output a signal that can be transmitted as input to a multilayer perceptron classifier 36. The modules 32, 34 and 36 together can compose the overall objectivity classifier module 14.

The Explicit Feature Driven Objectivity Classifier discussed above, requires the extraction of features, which can be cumbersome. In order to avoid the burden of explicit feature engineering, the implicit objectivity classifier 31 can be implemented, which learns the implicit representation of a sentence for the specified task of objectivity classification and this representation can be fed to the multilayer perceptron classifier 36 for classification decision.

A task of the sentence-embedding layer 32 can be to generate the sentence matrix given a textual sentence (e.g. input sentence 12). In the embedding layer, a word embedding sentence matrix can constructed for the input sentence 12 using word embeddings. Thus, the input sentence 12 can be provided to the sentence-embedding layer 32. Output from the sentence-embedding layer 32 can be provided as input to the sentence encoding LSTM 34.

Note that the term “layer” as utilized herein can refer to as neural network layer. That is, a neural network can be formed in three layers, including an input layer, a hidden layer and an output layer. Each layer can be composed of one or more nodes with nodes of the hidden and output layer being active.

A sentence-embedding matrix can be encoded using the LSTM 34. Note that in an example embodiment, a recurrent neural network (RNN) with the LSTM 34 can be used as an encoder (or encoders) for the basic sentence representation. That is, the LSTM 34 can comprise an RNN that includes an LSTM. Long short-term memory (LSTM) units are units of an RNN. The RNN can be composed of LSTM units, which may be arranged in a network architecture referred to as an LSTM network. An LSTM unit can include a cell, an input gate, an output gate and a forget gate. The cell can remember values over arbitrary time intervals and the three gates can regulate the flow of information into and out of the cell.

An aspect of LSTM 34 is that it can contain memory cells, which can store information for a long period of time and hence may not suffer from the vanishing gradient problem. The encoded sentence representation can be then fed to a multilayer perceptron (MLP) classifier 36. The MLP classifier 36 can be implemented as a multilayer fully connected feed forward network with appropriate regularization and dropout applied.

The last layer is a softmax layer with two classes. Note that the term softmax can relate to a softmax function that can be used in a final layer of a neural network-based classifier. Such networks can be trained under a log loss (or cross-entropy) regime, giving a non-linear variant of multinomial logistic regression. In an embodiment, a neural network classifier can be trained end-to-end using cross-entropy loss. Once a claim sentence has been found to be objective, a next step can be to determine whether it contains information, which may be of interest to a general section of the public. This step can be accomplished by the second stage of our classification pipeline—namely the public interestingness classifier 16, which is described in greater detail below.

Given an objective sentence, the public interestingness classifier 16 attempts to classify whether that sentence contains information, which can be of interest to a section of the public and which may require verification. However, identifying sentences, which contain information of interest to public, can be a challenging task. As in the case of the objectivity classifier 14, we propose two models for a binary classifier: (a) an explicit feature driven public interestingness classifier; and (b) an implicit featureless classifier using the neural sentence representation.

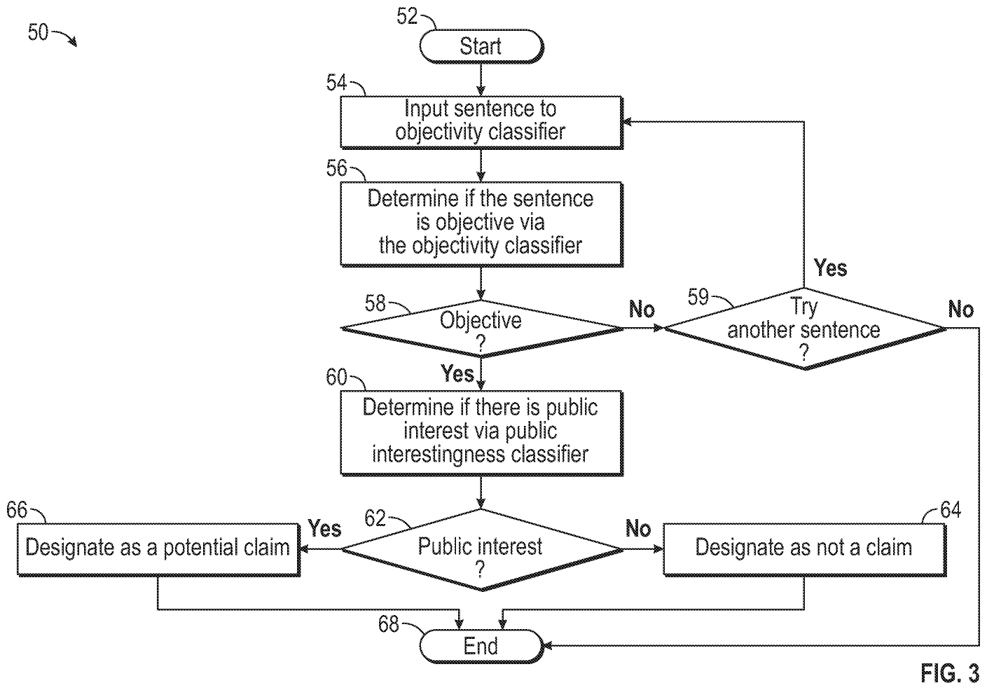

FIG. 3 illustrates a high-level flow chart depicting logical operational steps of a method 50 for determining if a claim is check-worth for fact checking, in accordance with an embodiment. As shown at block 52, the process begins. Then, as indicated at block 54, a step or operation can be implemented in which a sentence stating a claim can be input to an objectivity classifier such as the objectivity classifier 14 discussed herein. This begins the first stage of the process.

A step or operation can be then implemented depicted at block 56, in which the objectivity classifier 56 can analyze the sentence and its claim and can classify the claim as either an objective claim or a subjective claim. If it is determined that the claim is not an objective claim, as shown at decision block 58, an additional operation can be performed, as depicted at decision block 59 to determine if another sentence with a claim should be attempted.

If so, then the operations shown at blocks 54 and 56 are processed again with respect to the new sentence and its claim. Otherwise, the process terminates, as shown at block 68. If the objectivity classifier classifies the claim as objective then as illustrated at block 58, a second stage an be implemented in which a determination can be made as to whether there is a public interest in the objective claim, as indicated at block 60. That is, as shown at block 60, this determination can be made via the public interestingness classifier 16 discussed herein.

If the public interestingness classifier 16 determines that yes, there is a public interest then as shown at decision block 62 and block 66, the claim can be designated as a potential claim with sufficient check-worthiness for fact checking. If not, then as shown at decision block 62 and block 64, the claim can be designated as not a check-worthy claim, and the process can then end, as shown at block 68.

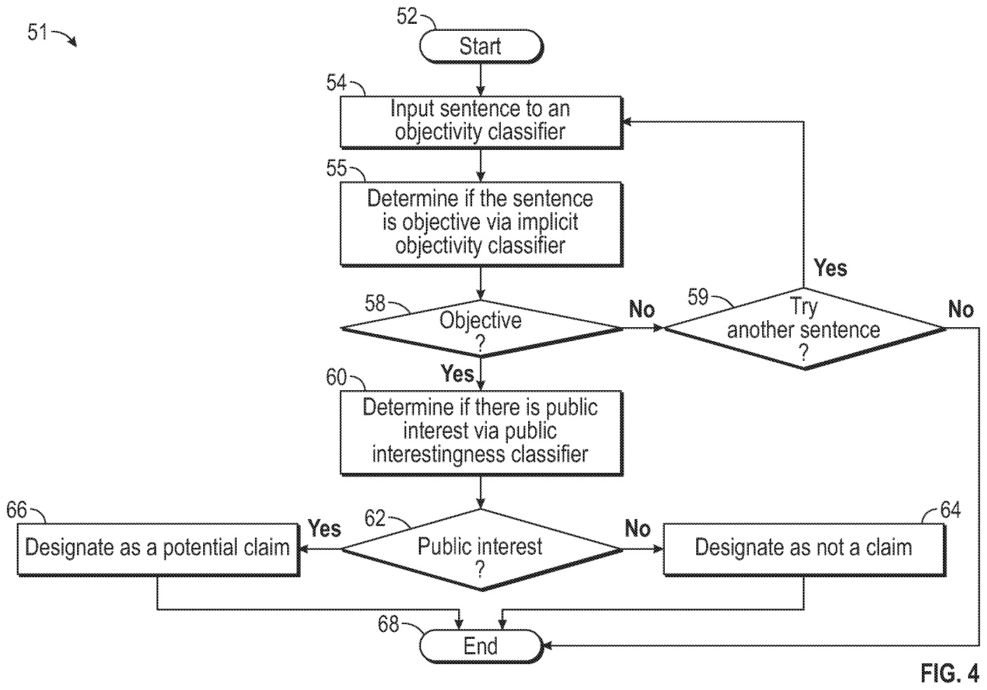

FIG. 4 illustrates a high-level flow chart depicting logical operational steps of a method 51 for determining if a claim is check-worth for fact checking, in accordance with an alternative embodiment. Note that in FIGS. 3-4, similar or identical parts or elements are generally indicated by identical reference numerals. The method 51 shown in FIG. 4 is thus an alternative version of method 50 depicted in FIG. 3. A difference between the embodiment shown in FIG. 4 and the embodiment depicted in FIG. 3 is that as shown at block 55, a step or operation can be implemented in which the sentence with its claim can be input to a specific type of objectivity classifier (i.e., an implicit objectivity classifier such as the implicit objectivity classifier 31).

An objective sentence needs to contain information of interest to general public for it to be check worthy. But how does one determine what information would be of interest to public? Journalists when posed with this question, often reply “You know it when you see it, but find it difficult to give rationale to why they select a piece of information as of being interest to general public”. Given the ambiguity associated with this problem, we hypothesize that certain inherent characteristics are associated with informational interest criterion, and identify these characteristics.

We can base our identification of these characteristics on two earlier studies regarding the theme of interestingness of information. One study involved the problem of interestingness of information in discourse processing and another study analyzed the related problem of What is news?.

Roger C. Schank, “Interestingness: Controlling Inferences”, Artificial Intelligence, 12 (1979), 273-297 (hereinafter referred to as “Schank”), which is incorporated herein by reference, postulated that unusual things, which deviate from our expectations, are usually more interesting than usual or normal things. We capture this notion through the characteristic of surprise and incongruity. Schank also hypothesized that information related to certain concepts such as death, danger, power, sex, and so forth, are absolute interests to the public and hence are typically “interesting”. The disclosed embodiments capture this notion through a universal interest characteristic. The study regarding news values identified a set of themes, which are typically associated with newsworthiness. These themes are the power elite, celebrity, entertainment, surprise, good news, bad news, magnitude, relevance, follow-up, and newspaper agendas. We map the themes of power elite, celebrity, and entertainment to the prominence characteristic.

Relevance depends on the personality of the consumer and since our focus is in finding information that is of interest to any section of the general public, we do not model the notion of relevance. We also do may not model the themes of follow-up, and newspaper agenda since these themes may correspond to specific news. We can also drop the themes of “good news” and/or “bad news” since we only consider objective facts. The notion of surprise can be modeled under a surprise characteristic and/or an incongruity characteristic.

In addition to the characteristics from these two studies, we can also hypothesize that objective information on certain topics may also be of interest to the general public, and capture this notion through topical interest characteristics. For each identified characteristic, we can associate each characteristic with certain textual content level surrogate marker features. It should be appreciated that these characteristics and associated features are by no means exhaustive for representing the notion of public informational interest. For now, however, we can leave the development of a taxonomy of computational interestingness characteristics for future work. Our overall list of representative characteristics, which models the notion of public informational interest and the associated set of textual content based features that serve as proxies to identify these characteristics can be designated as follows:

Prominence Characteristic: The prominence characteristic can capture the notion that the public is interested in persons of consequence (e.g., people who are famous, powerful, elite, etc.). Hence, we can hypothesize that if a sentence contains information about entities that are famous, this would be of interest to the public. We can use the presence of the entity in external knowledge bases such as, for example, Wikipedia and Google Knowledge Graph as a surrogate measure of a prominence characteristic.

Universal interest characteristic: This represents the absolute interest concepts proposed by Schank. We use the words representing these concepts as a seed set and construct a universal interest lexicon by augmenting the seed set with semantically related neighbors from a word-vector space model. We use the word count of words from the Universal Interest lexicon as a feature.

Surprise and Incongruity Characteristic: Sentences that contain information, which are not in line with normal human expectations, can be of interest to the public. For instance, the sentence the moon appeared red yesterday may be of public informational interest whereas the sentence the moon appeared white may not be of public informational interest. The notion of surprise is difficult to capture through textual features alone and may be likely to be dependent on external knowledge. For instance, a Greek book, which states that Helen of Troy was disfigured can be inferred to contain an element of surprise only if we can model the background fact that Helen of Troy is believed to be beautiful by the general public. Given the difficulty of modeling in external and common sense knowledge, this characteristic can be represented by a simple textual feature of looking or searching for an unexpected/unusual set of word combinations.

Given a sentence, if we find key words that normally do not appear together in the same context, we can consider it as an unusual set of word combinations and thus as an indicator of word incongruity. For example, moon and red are not often expected to appear together. In order to compute such incongruent word combinations, key words can be identified in the sentence, and their semantic relatedness computed using a word vector space model. If the semantic relatedness is below a specified threshold, we can mark or designate the result as indicating the presence of an incongruent word combination. Note that the term “key words” or “key word” as used herein can relate to ideas and topics that define what the content is about. Key words are important because they are the linchpin between what people are searching for and the content that is being provided to fill that need. A “key word” may also serve as a key, as to the meaning of another word, a sentence, passage, or the like.

Magnitude Characteristic: This represents the magnitude/numbers that get expressed in an objective sentence. We represent this by looking for presence of numerical quantities in the sentence.

Topical Interest Characteristic: Certain topics such as finance, health, politics, sports, and war are of interest to general public. A set of predefined categories can be defined and he category of each sentence can be identified as belonging to one of these categories as a feature for representing the Topical Interest Characteristic.

In addition to the above features, we also use represent the semantics of the sentence by creating a sentence embedding representation using word vector embedding and using it as an additional feature to the classifier. The constructed feature vector for the input is then fed to a standard supervised learning based classifier. We experiment with different classifiers as discussed in experimental and results section.

The design of the disclosed implicit public interestingness classifier 31 can be similar to that of the objectivity classifier 14 (e.g., which can be an implicit objectivity classifier) with the difference that the neural network can be trained end-to-end using public interestedness labels instead of objectivity labels. Hence, this feature is not described in detail herein.

Experimental embodiments have been implemented, which involve the use of public datasets (e.g., MPQA, Snopes, ROC stories, and fact checking by Vlachos) for forming the hybrid dataset. It should be appreciated that these are examples of some public datasets, and that other embodiments may employ different public datasets. In this particular experimental embodiment, using 2500 sentences from Snopes, 2500 sentences from ROC stories and remaining 9693 from MPQA formed a total of 14693 sentences.

The statistics of the new dataset formed are shown in Table 1. It should be appreciated that the data shown in Table 1 to Table 5 herein is experimental in nature and thus are not limiting features of the disclosed embodiments. Table 1 to Table 5 are included herein for exemplary and edification purposes only and do not limit the embodiments to this particular data.

In general, each sentence can be considered as a document. Each sentence can be independent; hence, there may be no contextual relation between two consecutive sentences. The data can be split as, for example, 70% for training and 30% for testing, with five fold cross validation used across the training data. In these experimental embodiments, performance was measured using precision, recall, accuracy and a confusion matrix across each stage of the classifier separately and together. In order to measure performance for a two-stage classifier together, a part of the hybrid dataset was used—around 2250 sentences for validation. In addition, a python toolkit was employed to code and perform such experiments.

TABLE 1
Statistics of the Hybrid dataset

| | | | Average | |
|---|---|---|---|---|
| | Minimum | Maximum | word | |
| Dataset | words | words | length | Length |
| Combined- | 3 | 294 | 20 | 14693 |
| hybrid | | | | |
| MPQA | 5 | 294 | 25 | 9693 |
| Stories | 3 | 16 | 8 | 2500 |
| Snopes | 4 | 191 | 16 | 2500 |

Features can be formed for each stage of the classifier and multiple classifiers such as logistic regression, random forest, SVM, can be used to measure the performance. Apart from this ablation, the study was performed by removing some of the features so as to determine the best performing feature set. The features used for each of the classifiers are outlined below. For example, features used for objective classifiers are as follows:

BoW features: The documents were pre-processed to remove the stop words, exclude the punctuation marks and implement a lemmatization operation. Note that the term lemmatization is a linguistic term that relates to a sorting of words by grouping inflected or variant forms of the same word. The normalized sentences can be then passed on to vectorize the sentences for training data and the same model used for test data. A standard TF-IDF weighted bag of words features (e.g., with a vocabulary of 5000 words) can then be created.

Part-of-speech-tagging (POS) features: Count of POS features for noun (NN,NNS,NNP,NNPS,PRP,WP), verb (VB,VBD,VBG,VBN,VBP,VBZ), adjective/adverb (JJ,JJR,JJS,RB,RBR,RBS,WRB) and negative words presence (none, neither, no, never, not) were used.

Sentiment score: A NLTK Vader sentiment analyzer can be used to obtain the polarity scores of the document. A compound score of a threshold more than 0.5 can be considered as a positive sentiment, otherwise a negative sentiment.

Subjective lexicon: The subjective lexicon can be used from a MPQA website. The presence or absence of the words after pre-processing can be extracted.

In this example, a total length of 5017 feature dimension was formed for this objectivity classifier with a binary label. The following features were extracted for the public interestingness classifier:

Presence of question mark: The feature with presence/absence of question mark was checked in document to capture the interrogation with public interestedness.

Part-of-speech-tagging (POS) features: Count of POS features for verb (VB,VBD,VBG,VBN,VBP,VBZ) and personal pronoun (WP,PRP) was used.

Named Entity recognition (NER) count features: In order to check for the number of entities present and their count in each sentence, the spaCy toolkit was used. Note that spaCy is an open-source software library for advanced NPL (Natural Language Processing), written in the programming languages Python and Cython. All 18 entities provided by the spaCy tool were used, namely person, groups based on nationalities/political/religious, facilities, organizations, geography and non-geography location, products, event, law, art, language, date, time, percent, money, quantity, ordinal and cardinal.

Presence of entity in Wikipedia: Each entity in the sentence after identified by spaCy, was passed on to a Wikipedia python library API to check for the page presence or absence. The count of the Wikipedia page presence for each entity was taken as a feature.

Word2vec embedding: A Google word2vec word embedding of dimension 300 for each word was used. The average of the word embedding for each word in the document after stop word removal was taken as the sentence embedding for the document.

A total length of 346 feature dimension was formed for this public interestingness classifier with binary label.

The features used in baseline classifier are:

Part-of-speech-tagging features: Count of POS tags for verb (VB, VBD, VBG, VBN, VBP, VBZ), noun (NN, NNS, NNP, NNPS, PRP, WP), adjective/adverb (JJ, JJR, JJS, RB, RBR, RBS, WRB) and negative tag (none, neither, no, never, not) were used.

Subjectivity lexicon: The presence or absence of words from a subjectivity lexicon can be taken as a feature.

BoW feature: Somewhat similar to an objective classifier, the same 5000 dimensional feature was taken.

NER count: The count of entities from spaCy for each sentence and the presence/absence of Wikipedia page for each entity was checked and its frequency was counted for each entity.

A total length of 5035 feature dimension was used for baseline classifier. The binary labels for the baseline classifier was formed with positives from both the objective and public interestedness label as a positive label for a check worthy claim. Other samples were taken as negative.

For validating the two-stage classifier, the validation data was passed on to both classifiers and the predictions of both classifiers were compared to obtain the prediction of a two-stage classifier. This prediction result was used to generate the performance metrics.

The results for the individual classifiers are provided below for logistic, random forest and SVM classifiers in Table 2, 3 and 4 respectively.

TABLE 2
Results for objectivity classifier

| | | | | F1 | Confusion |
|---|---|---|---|---|---|
| Model | Accuracy | Precision | Recall | score | matrix |
| Logistic | 83.68 | 85 | 84 | 84 | [[1767 348]] |
| | | | | | [[371 1922]] |
| Random | 79.78 | 83 | 78 | 80 | [[1738 377]] |
| Forest | | | | | [[514 1779]] |
| SVM | 84.00 | 86 | 83 | 84 | [[1801 31]] |
| | | | | | [[391 1902]] |

TABLE 3
Results for public interestingness classifier

| | | | | F1 | Confusion |
|---|---|---|---|---|---|
| Model | Accuracy | Precision | Recall | score | matrix |
| Logistic | 93.9 | 95 | 96 | 96 | [[647 81]] |
| | | | | | [[56 1467]] |
| Random | 92.4 | 92 | 97 | 95 | [[606 122]] |
| Forest | | | | | [[49 1474]] |
| SVM | 94 | 95 | 96 | 96 | [[648 80]] |
| | | | | | [[55 1468]] |

TABLE 4
Results for baseline classifier

| | | | | F1 | Confusion |
|---|---|---|---|---|---|
| Model | Accuracy | Precision | Recall | score | matrix |
| Logistic | 78.56 | 70 | 64 | 67 | [[2506 401]] |
| | | | | | [[544 957]] |
| Random | 75.97 | 71 | 50 | 59 | [[2598 309]] |
| Forest | | | | | [[750 751]] |
| SVM | 78.60 | 71 | 63 | 67 | [[2512 395]] |
| | | | | | [[548 953]] |

TABLE 5
Results for hybrid two-stage classifier with other classifiers

| Random | | | | | |
|---|---|---|---|---|---|
| forest | | | | F1 | Confusion |
| model | Accuracy | Precision | Recall | score | matrix |
| Baseline | 82.31 | 95 | 78 | 86 | [[668 60]] |
| classifier | | | | | [[338 1185]] |
| Hybrid | 86.58 | 100 | 80 | 89 | [[727 1]] |
| two stage | | | | | [[301 1222]] |
| classifier | | | | | |
| Objective | 88.05 | 100 | 83 | 90 | [[722 6]] |
| classifier | | | | | [[263 1260]] |
| Public | 92.40 | 92 | 97 | 95 | [[606 122]] |
| interestingness | | | | | [[49 1474]] |
| classifier | | | | | |

As seen from Table 5, the two-stage classifier can perform better than the baseline classifier, which is objective and public interest. The prediction accuracy can be approximately 4%, which is an improvement compared to baseline. The same can be reflected across various metrics such as precision, recall and F1 score. Thus, it can be appreciated that the disclosed embodiments can help in reducing the workload of automated systems (e.g., data-processing system 400) and save time in performing the fact-checking operations. The ability to reduce the workload of an automated system (e.g., a computer, a server, a computing network, etc) is one of the advantages of the disclosed embodiments. Efficiencies in the underlying technology such as improved processing time and reduced workload in an automated system can be improved via the disclosed approach. This can also result in energy savings in such automated systems.

It should be appreciated that the features described above and elsewhere herein do not constitute an exhaustive list of features, but are merely representative of important features that can be potentially employed to represent objectivity and interestingness. The disclosed embodiments can cover additional features, which may be finer aspects of the features listed herein.

It should be appreciated that the order of the various steps, operations instructions shown at the various blocks in FIGS. 1-6 herein can be arranged or implemented in a different order or with fewer or more steps, operations and instructions or elements. In other words, the particular ordering of elements shown in FIGS. 1-6 is not a limiting feature of the disclosed embodiments.

As can be appreciated by one skilled in the art, example embodiments can be implemented in the context of a method, data-processing system, or computer program product. Accordingly, some embodiments may take the form of a hardware embodiment, a software embodiment or an embodiment combining software and hardware aspects generally referred to herein as a “circuit” or a “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, and so on.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., Wi-Fi, Wimax, 802.xx, and cellular network or the connection may be made to an external computer via most third party supported networks (for example, through the Internet utilizing an Internet Service Provider).

The disclosed example embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, a special-purpose computer, or another programmable data processing apparatus to produce a machine, such that the instructions, which execute via the processor of the computer or other programmable data processing apparatus, can create a device or system for implementing the functions/acts specified in the block or blocks.

To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer.

The aforementioned computer program instructions may also be stored in a computer-readable memory (e.g., such as memory 342, memory 106 and so on) that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the blocks may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special purpose hardware and computer instructions.

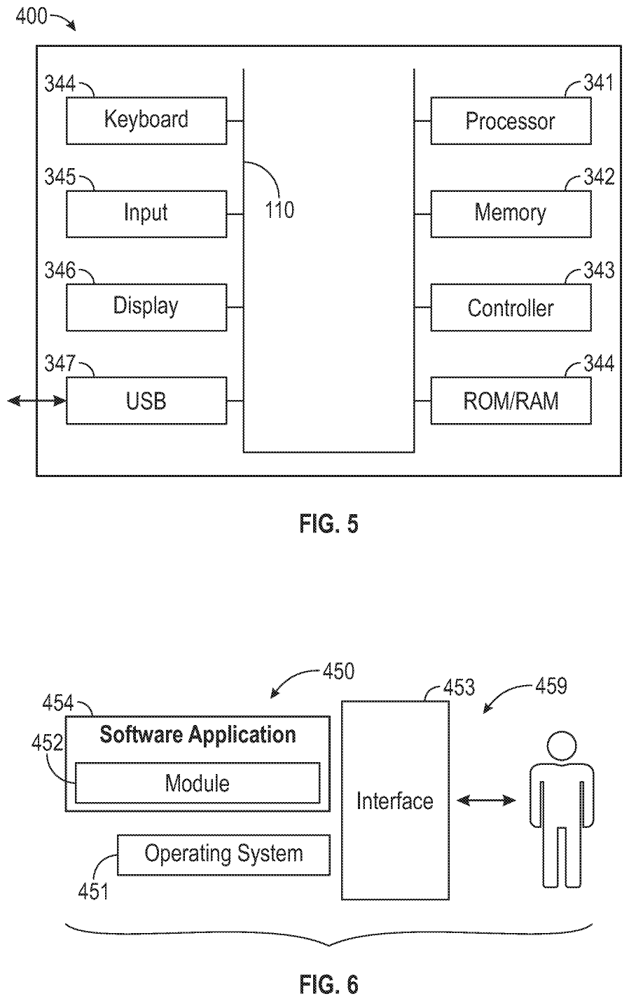

FIGS. 5-6 are shown only as exemplary diagrams of data-processing environments in which example embodiments may be implemented. It should be appreciated that FIGS. 5-6 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 5, some embodiments may be implemented in the context of a data-processing system 400 that can include, for example, one or more processors such as a processor 341 (e.g., a CPU (Central Processing Unit) and/or other microprocessors), a memory 342, a controller 343, additional memory such as ROM/RAM 332 (i.e. ROM and/or RAM), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc) and/or other peripheral connections and components.

The system bus 110 can serve as the main electronic information highway interconnecting the other illustrated components of the hardware of data-processing system 400. In some embodiments, the processor 341 may be a CPU that functions as the central processing unit of the data-processing system 400, performing calculations and logic operations required to execute a program. Such a CPU, alone or in conjunction with one or more of the other elements disclosed in FIG. 4, is an example of a production device, computing device or processor. Read only memory (ROM) and random access memory (RAM) of the ROM/RAM 344 constitute examples of non-transitory computer-readable storage media.

The controller 343 can interface with one or more optional non-transitory computer-readable storage media to the system bus 110. These storage media may include, for example, an external or internal DVD drive, a CD ROM drive, a hard drive, flash memory, a USB drive, etc. These various drives and controllers can be optional devices. Program instructions, software or interactive modules for providing an interface and performing any querying or analysis associated with one or more data sets may be stored in, for example, ROM and/or RAM 344. Optionally, the program instructions may be stored on a tangible, non-transitory computer-readable medium such as a compact disk, a digital disk, flash memory, a memory card, a USB drive, an optical disc storage medium and/or other recording medium

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server). The network 110 discussed previously can be implemented as, for example, a client-server based network.

In some example embodiments, the data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc).

FIG. 6 illustrates a computer software system 450 for directing the operation of the data-processing system 400 depicted in FIG. 5. The software application 454, stored for example in memory 342 and/or another memory, generally includes one or more modules such as module 452. The computer software system 450 also includes a kernel or operating system 451 and a shell or interface 453. One or more application programs, such as software application 454, may be “loaded” (i.e., transferred from, for example, mass storage or another memory location into the memory 342) for execution by the data-processing system 400.

The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as discussed herein. Examples of module 453 include but are not limited to modules such as the scanning module 104 and the search and matching module 108 discussed previously.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can include the software application 454, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be private (accessible only to that module) and which can include source code that actually implements the routines in the module. The term module may also simply refer to an application, such as a computer program designed to assist in the performance of a specific task, such as word processing, accounting, inventory management, etc. In some example embodiments, the term “module” can also refer to a modular hardware component or a component that is a combination of hardware and software. Examples of modules include the various elements discussed and described herein. A module or group of modules can implement the various elements, instructions, steps and/or operations described herein.

FIGS. 5-6 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms and/or operating systems, including, for example, Macintosh/Apple (e.g., Mac OSx, iOS), UNIX, LINUX, Windows, Android, and so on.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

Based on the foregoing, it can be appreciated that a number of embodiments (preferred and alternative embodiments) are disclosed herein. For example, in one embodiment, a method for automatically selecting a claim for fact checking, can be implemented. Such a method can include: in a first stage, classifying a claim as objective or subjective; in a second stage, classifying the claim as being of public interest or not, if the claim was classified as objective in the first stage; and selecting the claim for fact checking if the claim is classified as both objective in the first stage and of public interest in the second stage.

The claim (e.g., represented in a textual sentence or other format) can be classified as objective or subjective utilizing an objectivity classifier. In some embodiments, the objectivity classifier can be an explicit feature driven objectivity classifier. In other embodiments, the objectivity classifier can be an implicit objectivity classifier. In some embodiments, the objectivity classifier can include an embedding layer, an encoder and a multilayer perceptron classifier, as discussed previously herein.

In another embodiment, a step or operation can be provided for curating a data set composed of the claim among a plurality of claims from multiple domains. In some embodiments, the claim can be classified as being of public interest or not via a public interestedness classifier comprising an explicit feature driven public interestedness classifier. In still another embodiment, a step or operation can be implemented for expressing the claim as a textual representation. In some embodiments, the claim can be classified as being of public interest or not via a public interestedness classifier comprising an implicit featureless classifier using a neural sentence representation.

In another example embodiment, a system for automatically selecting a claim for fact checking, can be implemented. Such a claim can include one or more computers with executable instructions that when executed cause the system to: in a first stage, classify a claim as objective or subjective; in a second stage, classify the claim as being of public interest or not, if the claim was classified as objective in the first stage; and select the claim for fact checking if the claim is classified as both objective in the first stage and of public interest in the second stage.

In another example embodiment, a computer program product for automatically selecting a claim for fact checking by a processor, can be implemented wherein the computer program product includes a non-transitory computer-readable storage medium having computer-readable program code portions stored therein. The computer-readable program code portions can include: an executable portion that in a first stage, classifies a claim as objective or subjective; an executable portion that in a second stage, classifies the claim as being of public interest or not, if the claim was classified as objective in the first stage; and an executable portion that selects the claim for fact checking if the claim is classified as both objective in the first stage and of public interest in the second stage.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for automatically selecting a claim for fact checking, comprising:
in a first stage, classifying a claim as objective or subjective;
in a second stage, classifying said claim as being of public interest or not, if said claim was classified as objective in said first stage; and
selecting said claim for fact checking if said claim is classified as both objective in said first stage and of public interest in said second stage.

2. The method of claim 1 wherein said claim is classified as objective or subjective utilizing an objectivity classifier.

3. The method of claim 2 wherein said objectivity classifier comprises an explicit feature driven objectivity classifier.

4. The method of claim 2 wherein said objectivity classifier comprises an implicit objectivity classifier.

5. The method of claim 2 wherein said objectivity classifier comprises an embedding layer, an encoder and a multilayer perceptron classifier.

6. The method of claim 1 further comprising curating a data set composed of said claim among a plurality of claims from multiple domains.

7. The method of claim 1 wherein said claim is classified as being of public interest or not via a public interestedness classifier comprising an explicit feature driven public interestedness classifier.

8. The method of claim 1 further comprising expressing said claim as a textual representation.

9. The method of claim 1 wherein said claim is classified as being of public interest or not via a public interestedness classifier comprising an implicit featureless classifier using a neural sentence representation.

10. A system for automatically selecting a claim for fact checking, comprising: one or more computers with executable instructions that when executed cause the system to:
in a first stage, classify a claim as objective or subjective;
in a second stage, classify said claim as being of public interest or not, if said claim was classified as objective in said first stage; and
select said claim for fact checking if said claim is classified as both objective in said first stage and of public interest in said second stage.

11. The system of claim 10 wherein said claim is classified as objective or subjective utilizing an objectivity classifier.

12. The system of claim 11 wherein said objectivity classifier comprises at least one of: an explicit feature driven objectivity classifier and an implicit objectivity classifier.

13. The system of claim 11 wherein said objectivity classifier comprises an embedding layer, an encoder and a multilayer perceptron classifier.

14. The system of claim 10 wherein said executable instructions further: curate a data set composed of said claim among a plurality of claims from multiple domains.

15. The system of claim 10 wherein said claim is classified as being of public interest or not via a public interestedness classifier comprising an explicit feature driven public interestedness classifier.

16. The system of claim 10 wherein said executable instructions further: express said claim as a textual representation.

17. The system of claim 10 wherein said claim is classified as being of public interest or not via a public interestedness classifier comprising an implicit featureless classifier using a neural sentence representation.

18. A computer program product for automatically selecting a claim for fact checking by a processor, the computer program product comprising a non-transitory computer-readable storage medium having computer-readable program code portions stored therein, the computer-readable program code portions comprising:
an executable portion that in a first stage, classifies a claim as objective or subjective;
an executable portion that in a second stage, classifies said claim as being of public interest or not, if said claim was classified as objective in said first stage; and
an executable portion that selects said claim for fact checking if said claim is classified as both objective in said first stage and of public interest in said second stage.

19. The computer program product of claim 18 wherein said claim is classified as objective or subjective utilizing an objectivity classifier comprising at least one of: an explicit feature driven objectivity classifier and an implicit objectivity classifier.

20. The computer program product of claim 18 wherein said objectivity classifier comprises an embedding layer, an encoder and a multilayer perceptron classifier.
